(19) United States
(12) Patent Application Publication
(10) Pub. No.: US 2024/0210999 A1
(43) Pub. Date: Jun. 27, 2024

(54) ENCAPSULATION COVER PLATE AND PREPARATION METHOD THEREOF, AND DISPLAY DEVICE

(71) Applicants: Chengdu BOE Optoelectronics Technology Co., Ltd., Chengdu, Sichuan (CN); BOE Technology Group Co., Ltd., Beijing (CN)

(72) Inventors: Yongxiao Gao, Beijing (CN); Tiejun Bi, Beijing (CN); Qiang Tang, Beijing (CN); Zhihui Wang, Beijing (CN); Xi Zhu, Beijing (CN); Chen Li, Beijing (CN)

(73) Assignees: Chengdu BOE Optoelectronics Technology Co., Ltd., Chengdu, Sichuan (CN); BOE Technology Group Co., Ltd., Beijing (CN)

(21) Appl. No.: 17/918,393

(22) PCT Filed: Nov. 8, 2021
(86) PCT No.: PCT/CN2021/129210

§ 371 Date: Oct. 12, 2022

(51) Int. Cl. G06F 1/16

(52) U.S. Cl. CPC G06F 1/1656; G06F 1/1607

(57) ABSTRACT

An encapsulation cover plate and a preparation method thereof, and a display device, which relates to the technical field of display. The encapsulation cover plate is configured for encapsulating a display panel, the encapsulation cover plate includes: an ultra-thin glass, wherein the ultra-thin glass is provided with a first surface for being close to the display panel and a second surface opposite to the first surface; and a coating layer coated on the first surface and/or the second surface, wherein a material of the coating layer includes an organic material.

### TECHNICAL FIELD

The present disclosure relates to the technical field of display and, more particularly, to an encapsulation cover plate and a preparation method thereof, and a display device.

### BACKGROUND

With the development of the technology of display, more and more foldable display products appear in the consumer market, and the market demand for the reliability of the foldable display products is also increasing.

In the related art, in order to improve the crease problem of the foldable display products, an ultra-thin glass is generally used as the cover plate of the display module.

### SUMMARY

The present disclosure provides an encapsulation cover plate, wherein the encapsulation cover plate is configured for encapsulating a display panel, the encapsulation cover plate includes:

an ultra-thin glass, wherein the ultra-thin glass is provided with a first surface for being close to the display panel and a second surface opposite to the first surface; and

a coating layer coated on the first surface and/or the second surface, wherein a material of the coating layer includes an organic material.

In an optional implementation, edges of an orthographic projection of the coating layer on a plane where the ultra-thin glass is located is protruded relative to edges of the ultra-thin glass, and a difference between a maximum value of a protruding amount and a minimum value of the protuding amount is less than or equal to 15 microns.

In an optional implementation, the coating layer includes a first coating layer and a second coating layer, and the second coating layer is coated on a side of the first coating layer away from the ultra-thin glass.

In an optional implementation, the coating layer includes at least two first coating layers and at least one second coating layer, and the first coating layer and the second coating layer are alternately arranged in stacked.

In an optional implementation, the material of the coating layer includes at least one of the following organic materials: polyester, polyurethane, thermoplastic polyurethane, polyamide, polyimide, polymethyl methacrylate, polyethylene, polypropylene, polyvinyl chloride, polystyrene, paraformaldehyde, polyphenylene oxide, polyphenylene sulfide, polysulfone, polyether ether ketone, styrene and polyolefin.

In an optional implementation, the material of the coating layer further includes at least one of the following inorganic materials: oxides, nitrides, carbides, borides, sulfides, silicides and functional ceramics.

In an optional implementation, a thickness of the coating layer is greater than or equal to 15 microns, and less than or equal to 300 microns.

In an optional implementation, edges of an orthographic projection of the coating layer on a plane where the ultra-thin glass is located is protruded relative to edges of the ultra-thin glass.

In an optional implementation, a protruding amount of the edges of the orthographic projection of the coating layer on the plane where the ultra-thin glass is located relative to edges of the ultra-thin glass is greater than or equal to 30 microns, and less than or equal to 100 microns.

In an optional implementation, the encapsulation cover plate further includes:
a shielding layer disposed on the first surface or on a side surface of the coating layer located on the first surface away from the ultra-thin glass, and the shielding layer is disposed close to an edge of the encapsulation cover plate; and/or
an adhesive film and an organic film arranged in stacked on the second surface or arranged in stacked on a side surface of the coating layer located on the second surface away from the ultra-thin glass, and the organic film is disposed on a side of the adhesive film away from the ultra-thin glass.

In an optional implementation, the encapsulation cover plate further includes:
an adhesive film and an organic film arranged in stacked on the second surface or arranged in stacked on a side surface of the coating layer located on the second surface away from the ultra-thin glass, and the organic film is disposed on a side of the adhesive film away from the ultra-thin glass; wherein the organic film includes a first area and a peripheral area located on a periphery of the first area, and an orthographic projection of the adhesive film on the plane where the ultra-thin glass is located is located within a range of an orthographic projection of the first area on the plane where the ultra-thin glass is located; and
a shielding layer disposed on a side of the organic film close to the ultra-thin glass, wherein an orthographic projection of the shielding layer on the plane where the ultra-thin glass is located is located within a range of an orthographic projection of the peripheral area on the plane where the ultra-thin glass is located.

In an optional implementation, the orthographic projection of the coating layer on the plane where the ultra-thin glass is located is provided with a protruding area, wherein the protruding area does not overlap with the ultra-thin glass, and the orthographic projection of the shielding layer on the plane where the ultra-thin glass is located covers the protruding area.

In an optional implementation, the orthographic projection of the organic film on the plane where the ultra-thin glass is located covers the orthographic projection of the coating layer on the plane where the ultra-thin glass is located.

The present disclosure provides a display device, wherein the display device includes the display panel and the encapsulation cover plate according to any one of the embodiments mentioned above, and the encapsulation cover plate is located at a light-emitting side of the display panel, the first surface is disposed close to the display panel.

The present disclosure provides a preparation method of an encapsulation cover plate, wherein the encapsulation cover plate is configured for encapsulating a display panel, the preparation method includes:
providing an ultra-thin glass, wherein the ultra-thin glass is provided with a first surface for being close to the display panel and a second surface opposite to the first surface; and
coating on the first surface and/or the second surface to form a coating layer, wherein a material of the coating layer includes an organic material.

In an optional implementation, the step of coating on the first surface and/or the second surface to form a coating layer includes:
providing a substrate film, wherein a material of the substrate membrane is an organic material;
adhering the substrate film to the first surface or the second surface of the ultra-thin glass, wherein edges of an orthographic projection of the substrate film on the plane where the ultra-thin glass is located is protruded relative to edges of the ultra-thin glass;
coating an organic solution on a side surface of the ultra-thin glass away from the substrate film, and solidifying the organic solution to form the coating layer; and
stripping the substrate film.

In an optional implementation, after the step of forming the coating layer, the preparation method further includes:
determining edges of the ultra-thin glass; and
based on the edges of the ultra-thin glass, cutting the coating layer, so that edges of an orthographic projection of the cut coating layer on the plane where the ultra-thin glass is located is protruded relative to edges of the ultra-thin glass, and a difference between a maximum value of a protruding amount and a minimum value of the protruding amount is less than or equal to 15 microns.

In an optional implementation, after the step of cutting the coating layer, the preparation method further includes:
forming a shielding layer on the first surface or on a side surface of the coating layer located on the first surface away from the ultra-thin glass, and the shielding layer is disposed close to an edge of the encapsulation cover plate; and/or
successively adhering an adhesive film and an organic film on the second surface or on a side surface of the coating layer located on the second surface away from the ultra-thin glass.

In an optional implementation, before the step of cutting the coating layer, the preparation method further includes:
providing an organic film, wherein the organic film includes a first area and a peripheral area located on a periphery of the first area;
forming a shielding layer on a side of the organic film, wherein an orthographic projection of the shielding layer on the plane where the ultra-thin glass is located is located within a range of an orthographic projection of the peripheral area on the plane where the ultra-thin glass is located.
successively adhering an adhesive film and the organic film on the second surface or on a side surface of the coating layer located on the second surface away from the ultra-thin glass, and the shielding layer on the organic film is disposed close to the ultra-thin glass; an orthographic projection of the adhesive film on the plane where the ultra-thin glass is located is located within a range of an orthographic projection of the first area on the plane where the ultra-thin glass is located; and
the step of cutting the coating layer includes:
cutting the coating layer and the organic film at a same time.

The above description is merely a summary of the technical solutions of the present disclosure. In order to more clearly know the elements of the present disclosure to enable the implementation according to the contents of the description, and in order to make the above and other purposes, features, and advantages of the present disclosure more apparent and understandable, the particular embodiments of the present disclosure are provided below.

### BRIEF DESCRIPTION OF THE DRAWINGS

In order to more clearly illustrate the technical solutions of the embodiments of the present disclosure or the prior art, the figures that are required to describe the embodiments or the prior art will be briefly introduced below. Apparently, the figures that are described below are embodiments of the present disclosure, and a person skilled in the art can obtain other figures according to these figures without paying creative work. It should be noted that the ratios in the drawings are merely illustrative and do not represent actual ratios.

FIG. 1 schematically illustrates a schematic diagram showing a sectional structure of a first encapsulation cover plate;

FIG. 2 schematically illustrates a schematic diagram showing a sectional structure of a second encapsulation cover plate:

FIG. 3 schematically illustrates a schematic diagram showing a plane structure of an encapsulation cover plate;

FIG. 4 schematically illustrates a schematic diagram showing a sectional structure of a third encapsulation cover plate;

FIG. 5 schematically illustrates a schematic diagram showing a sectional structure of a fourth encapsulation cover plate;

FIG. 6 schematically illustrates a schematic diagram showing a sectional structure of a fifth encapsulation cover plate;

FIG. 7 schematically illustrates a flow schematic chart of a preparation method of an encapsulation cover plate;

FIG. 8 schematically illustrates a flow chart of a preparation method of an encapsulation cover plate; and

FIG. 9 schematically illustrates a flow chart of a specific implementation of a preparation method of an encapsulation cover plate.

### DETAILED DESCRIPTION OF THE EMBODIMENTS

In order to make the objects, the technical solutions, and the advantages of the embodiments of the present disclosure clearer, the embodiments of the present disclosure will be clearly and completely described below with reference to the drawings of the embodiments of the present disclosure. Apparently, the described embodiments are merely certain embodiments of the present disclosure, rather than all of the embodiments. All of the other embodiments that a person skilled in the art obtains on the basis of the embodiments of the present disclosure without paying creative work fall within the protection scope of the present disclosure.

Experimental data show that an ultra-thin glass is more prone to fracture when it is impacted and squeezed by sharp objects and dropped, resulting in poor reliability of the foldable display products.

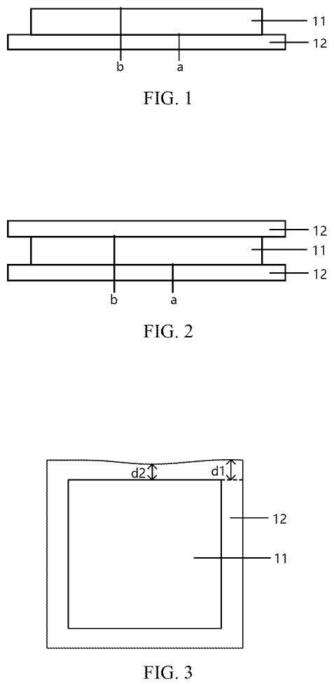

An embodiment of the present disclosure provides an encapsulation cover plate, wherein the encapsulation cover plate is configured for encapsulating a display panel. Referring to FIG. 1 and FIG. 2, FIG. 1 and FIG. 2 schematically illustrate a schematic diagram showing a sectional structure of an encapsulation cover plate according to the embodiment. As shown in FIG. 2, the encapsulation cover plate includes:
an ultra-thin glass 11, wherein the ultra-thin glass 11 is provided with a first surface a for being close to the display panel and a second surface b opposite to the first surface a; and
a coating layer 12 coated on the first surface a and/or the second surface b, wherein a material of the coating layer 12 includes an organic material.

The material of coating layer 12 may include an organic polymer material, and may also include an inorganic material, an additive, etc., which is not limited in the present embodiment.

In the specific implementation, the organic materials may be coated on the surface of the ultra-thin glass 11 by one or more of the coating processes such as spraying coating, flow coating, sputtering, slit coating, spin coating and scraping coating, thereby forming the coating layer 12.

In the present embodiment, since the coating layer 12 is coated on the surface of the ultra-thin glass 11, instead of being adhered to the surface of the ultra-thin glass 11 by an adhering method, the coating layer in the present embodiment has higher adhesive force on the surface of the ultra-thin glass and stronger tear resistance, which may improve the reliability of the encapsulation cover plate.

In a specific implementation, the ultra-thin glass 11 may be coated on one side, for example, the coating layer 12 is coated on the first surface a, as shown in FIG. 1. Alternatively, the coating layer 12 is coated on the second surface b. The ultra-thin glass 11 may also be double-sided coated, for example, the coating layer 12 is coated on the first surface a and the second surface b, as shown in FIG. 2.

For example, a thickness of the ultra-thin glass 11 may be greater than or equal to 15 microns and less than or equal to 150 microns. In specific applications, the ultra-thin glass with different thicknesses may be selected according to factors such as the bending radius of the display panel.

By coating the coating layer 12 on the first surface a and/or the second surface b of the ultra-thin glass 11, when the encapsulation cover plate is subjected to external impact or squeezing, the coating layer may absorb and transform part of the external force through its own elasticity or plastic deformation, thereby playing a role in protecting the ultra-thin glass 11 and improving the ability of the encapsulation cover plate to resist squeezing, impact and drop.

According to the inherent properties of brittle materials such as glass, the maximum compressive stress it may bear is 10 times of the maximum tensile stress it may bear, that is, the glass resists compression but does not resist tension. When the front of the ultra-thin glass is impacted or squeezed, the failure risk is relatively small due to the front is subjected to compressive stress. Comparing with the front which is subjected to the impact or squeezing, the strain and tensile stress on the back is greater, and may exceed the maximum elastic deformation range that the ultra-thin glass can bear and the maximum allowable tensile stress, resulting in fragmentation failure.

After the encapsulation cover plate provided in the present disclosure is configured for encapsulating a display panel, the second surface b is the surface that is subjected to compressive stress. Therefore, when the ultra-thin glass 11 is coated on one side, the coating layer 12 may be coated on the first surface a of the ultra-thin glass 11. In this way, when a side of the second surface b is impacted or squeezed by external forces, the coating layer 12 on the back that is the first surface a may give a supporting force to the ultra-thin glass 11, the distance of the tensile stress of the back is reduced and the maximum tensile stress which the back is subjected to is reduced. The coating layer 12 can play a role in strengthen the protection of the ultra-thin glass 11. The ability of the encapsulation cover plate to resist squeezing, impact and drop is further improved.

The inventors carried out a test experiment to the encapsulation cover plate provided in the present embodiment. The experimental results show that the coating layer 12 may effectively enhance the impact resistance performance, squeezing resistance performance and drop resistance performance of the ultra-thin glass 11, and the parameters such as the optical transmittance, haze and yellowing index of the encapsulation cover plate may not decrease significantly and are still within a controllable range. In addition, since the elastic modulus of the polymer material is relatively less, that is, the internal stress of the coating layer 12 on the ultra-thin glass 11 body is less, comparing with the ultra-thin glass 11 monomer, the bending performance of the ultra-thin glass 11 coated with the coating layer 12 may not be significantly reduced

In practical applications, the inventor found that in the process of preparing the encapsulation cover plate mentioned above, since the surface tension of the coated organic solution is relatively great, and the viscosity of the wet film is relatively less, the organic solution has a certain fluidity, resulting in that the coating layer 12 formed by solidifying has an overflow part relative to the ultra-thin glass 11. A width of the overflow part ranges from 100-200 μm to 300-500 μm, and is uneven. The overflowing coating layer 12 not only affects the appearance of the encapsulation cover plate, but also leads to poor alignment accuracy in subsequent printing, adhering and other processes.

In an optional implementation, edges of an orthographic projection of the coating layer 12 on a plane where the ultra-thin glass 11 is located is protruded relative to edges of the ultra-thin glass 11. In order to improve the alignment accuracy in subsequent processes, a difference between a maximum value of a protruding amount and a minimum value of the protruding amount is less than or equal to 15 microns.

The protruding amount mentioned above refers to the distance between the edges of the orthographic projection of the coating layer 12 on a plane where the ultra-thin glass 11 is located and the edges of the ultra-thin glass 11. Referring to FIG. 3, the maximum value of the protruding amount is the maximum distance d1 between the edges of the orthographic projection of the coating layer 12 on a plane where the ultra-thin glass 11 is located and the edges of the ultra-thin glass 11. The minimum value of the protruding amount is the minimum distance d2 between the edges of the orthographic projection of the coating layer 12 on a plane where the ultra-thin glass 11 is located and the edges of the ultra-thin glass 11.

The encapsulation cover plate provided in the present implementation may be obtained by cutting the coating layer 12 formed by solidifying. In the actual process, due to the limitation of cutting accuracy, the protruding amount of the coating layer 12 relative to the ultra-thin glass 11 fluctuates within the error range. Therefore, the difference between the maximum value of the protuding amount and the minimum value of the protruding amount may be determined according to the cutting accuracy.

For example, when the cutting error range is 0, the protruding amount of the coating layer 12 relative to the ultra-thin glass 11 may be a fixed value. When the cutting error range is ±5 microns, the difference between the maximum value and the minimum value of the protruding amount of the coating layer 12 relative to the ultra-thin glass 11 may be less than or equal to 10 microns. The difference between the maximum value of the protruding amount and the minimum value of the protruding amount is not limited in the present embodiment.

For the encapsulation cover plate provided in the present implementation, since the difference between the maximum value and the minimum value of the protruding amount of the coating layer 12 relative to the ultra-thin glass 11 is less, that is, the uniformity of the distance between the edges of the orthographic projection of the coating layer 12 on the plane where the ultra-thin glass 11 is located and the edges of the ultra-thin glass is high, and the tolerance is less, the alignment accuracy in the subsequent processes may be improved and the subsequent process difficulty may be reduced.

In addition, since the edges of the orthographic projection of the coating layer 12 on a plane where the ultra-thin glass 11 is located is protruded relative to edges of the ultra-thin glass 11, during the drop test, the protruding part of the coating layer 12 may first contact sandpaper or marble. The drop resistance of the display product is improved and the reliability of the display product is improved.

In an optional implementation, the protruding amount is greater than or equal to 30 microns, and less than or equal to 100 microns, which is not limited in the present embodiment. For example, the protruding amount may be 70 microns, which may be adjusted according to actual needs.

For the encapsulation cover plate provided in the present implementation, compared with a related art, the protruding amount of the coating layer 12 relative to the ultra-thin glass 11 is reduced, that is, the distance between the edges of the orthographic projection of the coating layer 12 on a plane where the ultra-thin glass 11 is located and the edges of the ultra-thin glass 11 is reduced. In the specific implementation, the protruding amount of the coating layer 12 relative to the ultra-thin glass 11 may be controlled by the cutting process to reduce the protruding amount.

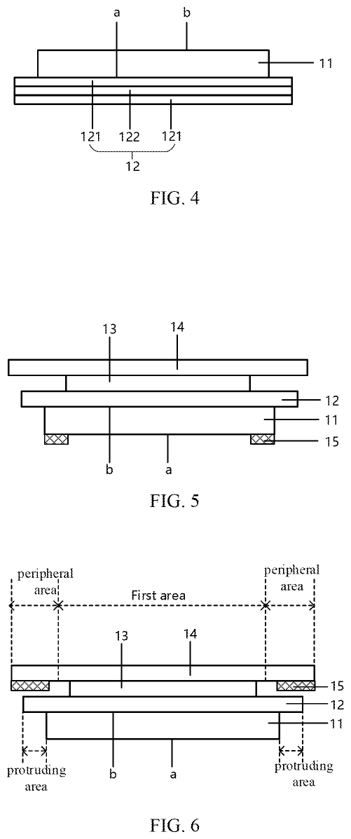

In the specific implementation, the coating layer 12 may be a single-layer structure, as shown in FIGS. 1 and 2. The coating layer 12 may also be a multi-layer structure, which is not limited in the present embodiment. In an optional implementation, as shown in FIG. 4, the coating layer 12 includes a first coating layer 121 and a second coating layer 122, and the second coating layer 122 is coated on a side of the first coating layer 121 away from the ultra-thin glass 11.

Specifically, an orthographic projection of the second coating layer 122 on the plane where the ultra-thin glass 11 is located may be completely overlapped with an orthographic projection of the first coating layer 121 on the plane where the ultra-thin glass 11 is located, so that the first coating layer 121 and the second coating layer 122 may be formed by a same cutting process to simplify the process.

In the present implementation, the adhesive force of the coating layer 12 and the encapsulation performance of the encapsulation cover plate are improved by coating multi-layer organic polymer materials on the ultra-thin glass 11.

Optionally, the coating layer 12 may include at least two first coating layers 121 and at least one second coating layer 122. As shown in FIG. 4, the coating layer 12 includes two first coating layers 121 and one second coating layer 122.

Optionally, the coating layer 12 may include a plurality of first coating layers 121 and a plurality of second coating layers 122.

Optionally, the first coating layer 121 and the second coating layer 122 are alternately arranged in stacked, as shown in FIG. 4. In this way, the adhesive force of the coating layer 12 may be further improved.

In the present embodiment, the material of the coating layer 12 may include at least one of the following organic materials: polyester, polyurethane, thermoplastic polyurethane, polyamide, polyimide, polymethyl methacrylate, polyethylene, polypropylene, polyvinyl chloride, polystyrene, paraformaldehyde, polyphenylene oxide, polyphenylene sulfide, polysulfone, polyether ether ketone, styrene and polyolefin and so on.

In a specific implementation, the material of the coating layer 12 may be selected from one or more of the organic materials, which is not limited in the present embodiment.

In the present embodiment, the material of the coating layer 12 may also include at least one of the following inorganic materials: inorganic materials such as oxides, nitrides, carbides, borides, sulfides and silicides, and inorganic additives such as glass, glass-ceramic and functional ceramics.

The functional ceramics include dielectric ceramics, optical ceramics, magnetic ceramics and semiconductor ceramics and so on. The composition of the functional ceramics may include one or more of AbO₃, Mg₂SiO₄, CaAs, CdTe, CdS and other materials.

In the specific implementation, one or more of the inorganic materials mentioned above may be filled in a solution of the organic materials, which is not limited in the present embodiment. The filling ratio of the inorganic materials may be determined according to actual needs.

By filling the inorganic materials in the solution of the organic materials, the problem of warpage by shrinkage of the coating layer 12 caused by solvent volatilization after the solidifying of the organic solution may be alleviated.

In the present embodiment, the coating layer 12 may also include a coupling agent and/or an adhesive agent to further improve the adhesive force of the coating layer 12.

The coupling agent is an additive that plays a role in coupling. The coupling agent may be silane coupling agent, titanate coupling agent, aluminate coupling agent, bimetallic coupling agent, phosphate coupling agent, borate coupling agent, and coupling agents of chromium complex and other higher fatty acids, alcohols, ester, and so on.

The adhesive agent may be additives that plays a role in cross-linking. The adhesive agent may include one or more of materials such as epoxy resins, phenolic resins, urea-formaldehyde resins, polyurethanes, polyvinyl acetal, perchloroethylene resins, chloroprene rubber, nitrile rubber, silicates and phosphates.

In an optional implementation, referring to FIG. 5, the encapsulation cover plate may further include:

an adhesive film 13 and an organic film 14 arranged in stacked on the second surface b or arranged in stacked on a side surface of the coating layer 12 located on the second surface b away from the ultra-thin glass 11, and the organic film 14 is disposed on a side of the adhesive film 13 away from the ultra-thin glass 11; and/or, a shielding layer 15 disposed on the first surface a or on a side surface of the coating layer 12 located on the first surface a away from the ultra-thin glass 11, and the shielding layer 15 is disposed close to an edge of the encapsulation cover plate.

Specifically, when the second surface b is coated with the coating layer 12, the adhesive film 13 and the organic film 14 are arranged in stacked on the side surface of the coating layer 12 located on the second surface b away from the ultra-thin glass 11, as shown in FIG. 5. When the second surface b is not coated with the coating layer 12, the adhesive film 13 and the organic film 14 is arranged in stacked on the second surface b.

When the first surface a is coated with the coating layer 12, the shielding layer 15 is disposed on the side surface of the coating layer 12 located on the first surface a away from the ultra-thin glass 11; when the first surface a is not coated with the coating layer 12, the shielding layer 15 is disposed on the first surface a, as shown in FIG. 5.

For example, the material of the shielding layer 15 may be an ink, which is not limited in the present embodiment. The shielding layer 15 plays the role in blocking the edge line and other structures of the display panel.

For example, the material of the organic film 14 may include one or more of the organic materials such as polyimide film, polyethylene terephthalate, polyethylene, polymethyl methacrylate, polycarbonate and thermoplastic polyurethane elastomer rubber, which are not limited by this embodiment, which is not limited in the present embodiment.

For example, the adhesive film 13 may be an optical adhesive, and the adhesive film 13 is configured for attaching the organic film 14 to the second surface b of the ultra-thin glass 11 or located on the coating layer 12 of the second surface.

In the specific implementation, the encapsulation cover plate may include the shielding layer 15 mentioned above, or include the adhesive film 13 and the organic film 14, or include the shielding layer 15, the adhesive film 13 and the organic film 14 (as shown in FIG. 5), which is not limited in the present embodiment.

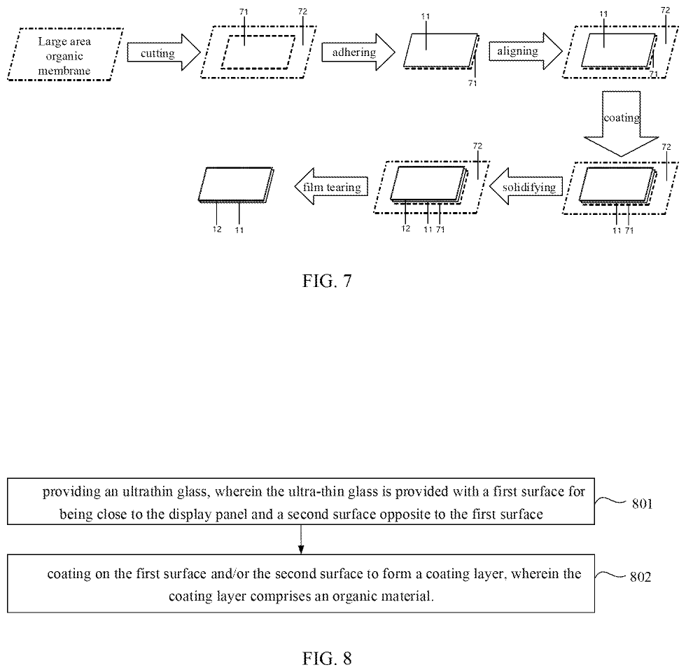

In another optional implementation, referring to FIG. 6, the encapsulation cover plate further includes: an adhesive film 13 and an organic film 14 arranged in stacked on the second surface b or arranged in stacked on a side surface of the coating layer 12 located on the second surface b away from the ultra-thin glass 11, and the organic film 14 is disposed on a side of the adhesive film 13 away from the ultra-thin glass 11; wherein the organic film 14 includes a first area and a peripheral area located on a periphery of the first area, and an orthographic projection of the adhesive film 13 on the plane where the ultra-thin glass 11 is located is located within a range of an orthographic projection of the first area on the plane where the ultra-thin glass 11 is located.

Specifically, when the second surface b is coated with the coating layer 12, the adhesive film 13 and the organic film 14 are arranged in stacked on the side surface of the coating layer 12 located on the second surface b away from the ultra-thin glass 11, as shown in FIG. 6. When the second surface b is not coated with the coating layer 12, the adhesive film 13 and the organic film 14 are arranged in stacked on the second surface b.

In the present implementation, referring to FIG. 6, the encapsulation cover plate further includes: a shielding layer 15 disposed on a side of the organic film 14 close to the ultra-thin glass 11, wherein an orthographic projection of the shielding layer 15 on the plane where the ultra-thin glass 11 is located is located within a range of an orthographic projection of the peripheral area on the plane where the ultra-thin glass 11 is located.

The orthographic projection of the coating layer 12 on the plane where the ultra-thin glass 11 is located is provided with a protruding area, wherein the protruding area does not overlap with the ultra-thin glass 11. In the specific implementation, the orthographic projection of the shielding layer 15 on the plane where the ultra-thin glass 11 is located covers the protruding area. According to the present implementation, by disposing the shielding layer 15 on the side of the coating layer 12 away from the first surface a of the ultra-thin glass 11, and the orthographic projection of the shielding layer 15 on the plane where the ultra-thin glass 11 may cover the protruding area, that is, the shielding layer 15 may block the overflowing coating layer 12, thereby improving the appearance.

In the present implementation, the orthographic projection of the organic film 14 on the plane where the ultra-thin glass 11 is located covers the orthographic projection of the coating layer 12 on the plane where the ultra-thin glass 11 is located.

In the present implementation, a thickness of the coating layer 12 may be greater than or equal to 15 microns, and less than or equal to 300 microns, which is not limited in the present embodiment. The thickness of the coating layer 12 refers to the dimension of the coating layer 12 in a direction perpendicular to the plane where the ultra-thin glass 11 is located.

It should be noted that when the encapsulation cover plate mentioned above does not include the adhesive film 13 and the organic film 14, in order to improve the impact resistance performance of the encapsulation cover plate, a coating layer 12 with a greater thickness may be disposed. For example, the thickness of the coating layer 12 may be greater than or equal to 100 microns and less than or equal to 300 microns. When the encapsulation cover plate includes the adhesive film 13 and the organic film 14, a coating layer 12 with a less thickness may be disposed. For example, the thickness of the coating layer 12 may be greater than or equal to 15 microns and less than or equal to 40 microns. In practical applications, the specific thickness of the coating layer 12 may be set according to actual needs.

The present disclosure further provides a display device, wherein the display device includes the display panel and the encapsulation cover plate according to any one of the embodiments.

It should be noted that the display device in the present embodiment may be: a display panel, an electronic paper, a mobile phone, a tablet computer, a television, a notebook computer, a digital photo frame, a navigator and any other product or component with a 2D or 3D display function.

The encapsulation cover plate is located at a light-emitting side of the display panel. The first surface is disposed close to the display panel.

The present disclosure further provides a preparation method of the encapsulation cover plate, wherein the encapsulation cover plate is configured for encapsulating a display panel, referring to FIG. 8, the preparation method includes:

Step 801: providing an ultra-thin glass, wherein the ultra-thin glass is provided with a first surface for being close to the display panel and a second surface opposite to the first surface; and

Step 802: coating on the first surface and/or the second surface to form a coating layer, wherein a material of the coating layer includes an organic material.

By using the preparation method provided by the present embodiment, the encapsulation cover plate described in any one of the embodiments may be obtained.

In step 802, a coating layer 12 may be formed by coating on the first surface a of the ultra-thin glass 11 to obtain the encapsulation cover plate as shown in FIG. 1. A coating layer 12 may be formed by coating on the second surface b of the ultra-thin glass 11. A coating layer 12 may also be formed by coating on the first surface a and the second surface b of the ultra-thin glass 11 to obtain the encapsulation cover plate as shown in FIG. 2.

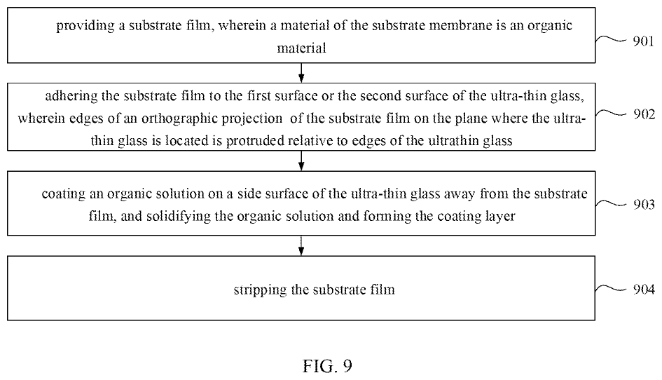

In the specific implementation, referring to FIG. 9, specifically, the step 802 may include:

Step 901: providing a substrate film, wherein a material of the substrate membrane is an organic material.

The substrate film can carny the ultra-thin glass and protect the ultra-thin glass from being scratched during the subsequent process. The substrate film may be selected from one or more organic membranes such as polyimide film, polyethylene terephthalate, polyethylene, polymethyl methacrylate, polycarbonate and thermoplastic polyurethane elastomer rubber and so on. When the material of the substrate film is polyethylene terephthalate, due to the high thermal stability of the polyethylene terephthalate material, the stability of the substrate film may be better maintained during the subsequent solidifying to the organic solution.

Referring to FIG. 7, FIG. 7 schematically illustrates a flow schematic chart of a preparation method of the encapsulation cover plate. As shown in FIG. 7, step 901 may specifically include: cutting the large area organic membrane, to obtain the substrate film 71 and a redundant membrane 72. The redundant membrane 72 has a hollow area corresponding to the substrate film 71. Wherein, the cutting process may be selected from die cutting or laser cutting.

Step 902: adhering the substrate film 71 to the first surface or the second surface of the ultra-thin glass 11, wherein edges of an orthographic projection of the substrate film 71 on the plane where the ultra-thin glass 11 is located is protruded relative to edges of the ultra-thin glass 11.

In the specific implementation, the substrate film 71 obtained by cutting may be adhered to the ultra-thin glass 11, as shown in FIG. 7. The adhering process may be selected from roller adhering, slider adhering or vacuum adhering and so on. In order to ensure the alignment accuracy and adhering effect, a vacuum adhering process may be used to adhere the substrate film 71 to the first surface or the second surface of the ultra-thin glass 11. At the same time, the vacuum defoaming process may also be used to remove the bubbles between the substrate film 71 and the ultra-thin glass 11 during the adhering process, to improve the flatness of a side surface of the ultra-thin glass 11 away from the substrate film 71, to avoid the uneven thickness of the coating layer caused by the uneven surface and reduce poor appearance.

The edges of the orthographic projection of the substrate film 71 on the plane where the ultra-thin glass 11 is located is protruded relative to the edges of the ultra-thin glass 11, that is, the edges of the adhered substrate film 71 is protruded relative to the edges of the ultra-thin glass 11. In this way, the ultra-thin glass 11 may be fully protected.

A size of the edges of the substrate film 71 protruded relative to the edges of the ultra-thin glass 11 may be greater than or equal to 50 microns, and less than or equal to 5000 microns. In the specific implementation, the size of the edges of the substrate film 71 protruded relative to the edges of the ultra-thin glass 11 may be determined according to the organic solution by the subsequent coating. When the fluidity of the organic solution is strong, the protruding size may be increased. When the fluidity of the organic solution is poor, the protruding size may be reduced. Wherein the protruding size refers to the minimum distance between the edges of the substrate film and the edges of the ultra-thin glass.

Step 903: coating an organic solution on a side surface of the ultra-thin glass 11 away from the substrate film 71, and solidifying the organic solution to form the coating layer.

In order to achieve precise alignment, the redundant membrane 72 obtained by cutting in step 901 may be tiled on a carrier plate, the edges of the redundant membrane 72 may be aligned with the edges of the carrier plate; then the substrate film 71 adhered on the ultrathin glass 11 is placed in the hollow area of the redundant film 72, as shown in FIG. 7, the substrate film 71 is placed close to the carrier plate, that is, a side surface of the ultrathin glass 11 away from the substrate film 71 is upward. The relative position of the ultra-thin glass 11 on the carrier plate is ensured to be fixed by this alignment process, thereby enabling precise alignment of the coating position.

Since the substrate film 71 adhered on the ultrathin glass 11 is placed in the hollow area of the redundant film 72, a side surface of the ultra-thin glass 11 away from the substrate film 71 is higher than the surface of the redundant film 72 away from the carrier plate. In this case, it is beneficial for the coating device to accurately identify the edges of the ultra-thin glass 11, thereby accurately locating the to-be-coated area and avoiding waste of the organic materials.

As shown in FIG. 7, after realizing the precise alignment, the organic solution may be coated on the side surface of the ultra-thin glass 11 away from the substrate film 71, and then the coated organic solution is solidified to form the coating layer 12.

When the coating layer is of a multi-layer structure, step 903 may be repeated several times between step 902 and step 904.

In order to achieve the effect of evenly coating, the coating process may be selected from one or more processes such as spraying coating, flow coating, sputtering, slit coating, spin coating and scraping coating.

In the specific implementation, the coating thickness of the organic solution may be greater than or equal to 1 nanometer, and less than or equal to 3000 microns. The coating thickness of the organic solution may be determined according to the thickness of the coating layer that needs to be formed, which is not limited in the present embodiment.

The solidifying process of the organic solution may be selected from one or more processes such as thermal solidifying and UV curing. The specific solidifying process may be selected according to the material properties of the organic solution. Wherein, the thermal solidifying may be selected from one or more of a baking oven or a tunnel furnace.

The solvents of the organic solution may include, but not be limited to, materials such as propylene glycol methyl ether acetate. The solutes of the organic solution may include, but not be limited to, one or more organic materials such as polyesters, polyurethanes, thermoplastic polyurethanes, polyamides, polyimides, polymethyl methacrylates, polyethylenes, polypropylenes, polyvinyl chlorides, polystyrenes, polyformaldehydes, polyphenylene ethers, polyphenylene sulfides, polysulfones, polyaryletherketones, styrenes, and polyolefins.

The organic solution may also include one or more inorganic materials such as oxides, nitrides, carbides, borides, sulfides, silicides, glass, glass-ceramics and functional ceramics. The filling ratio of inorganic materials may be determined according to actual needs. By filling inorganic materials in the solution of the organic materials, the problem of warpage by shrinkage of the coating layer 12 caused by solvent volatilization after the solidifying of the organic solution may be alleviated.

The organic solution may also include a coupling agent and/or an adhesive agent to further improve the adhesive force of the coating layer 12. Wherein the coupling agent is an additive that plays a role in coupling. The adhesive agent may be additives that plays a role in cross-linking.

Step 904: stripping the substrate film.

In the specific implementation, a small tearing hand may be pasted on an edge of a side of the substrate film away from the ultra-thin glass to facilitate tearing the film and reduce the unnecessary loss that may be caused during the stripping process of the substrate film.

When the ultra-thin glass needs to be coated on both sides, for example, the substrate film may be first adhered to the first surface of the ultra-thin glass, and the organic solution is coated on the second surface of the ultra-thin glass, and the organic solution is solidified to form a coating layer on the second surface, and the substrate film on the first surface is stripped. Then, the substrate film is adhered to the second surface where the coating of the coating layer is completed, an organic solution is coated on the first surface of the ultra-thin glass, and the organic solution is solidified to form a coating layer on the first surface, the substrate film on the second surface is stripped. Thus, the double-sided coating of the coating layer is completed.

It should be noted that when the ultra-thin glass is double-sided coated, the first surface may be coated first, or the second surface may be coated first, which is not limited in the present embodiment.

During the process of preparing the encapsulation cover plate mentioned above, since the surface tension of the coated organic solution is relatively large, and the viscosity of the wet film is relatively small, the organic solution has a certain fluidity, resulting in that the organic solution overflows the ultra-thin glass 11, and the coating layer 12 formed by solidifying has an overflow part relative to the ultra-thin glass 11. A width of the overflow part ranges from 100-200 μm to 300-500 μm, and uneven. The overflowing coating layer 12 not only affects the appearance of the encapsulation cover plate, but also leads to poor alignment accuracy in subsequent printing, adhering and other processes.

In order to improve the alignment accuracy in subsequent processes, in an optional implementation, after the step of forming the coating layer, the preparation method may further include: firstly, determining the edges of the ultra-thin glass; then, based on the edges of the ultra-thin glass, cutting the coating layer to make that edges of an orthographic projection of the cut coating layer on the plane where the ultra-thin glass is located is protruded relative to edges of the ultra-thin glass.

After the cutting process, a difference between a maximum value of a protruding amount and a minimum value of the protruding amount is less than or equal to 15 microns. A coating layer with a controllable width and a less tolerance protruded relative to the outer edges of the ultra-thin glass may be obtained. The alignment accuracy of the subsequent printing and/or the adhering process may be improved and the difficulty of the operation may be reduced.

In the specific implementation, the step of determining the edges of the ultra-thin glass may include: the edges of the ultra-thin glass is irradiated by a light source with a specific wavelength, and the edges of the ultra-thin glass is identified by using a CCD alignment device, then based on the edges of the ultra-thin glass, the preset value is expanded, then the overflowing coating layer is cut by using the laser, thereby, the width of the protruding part of the coating layer relative to the edges of the ultra-thin glass is controlled within a certain range.

The size, i.e. a preset numerical value, of the laser trajectory for cutting the coating layer outward expanded relative to the edges of the ultra-thin glass may be less than 100 microns, or less than 50 microns. The size of the preset numerical value may be set according to the size of the coating layer required after cutting and the size of the heat affected area of the laser trajectory, so that the protruding part of the coating layer after cutting relative to the edge of the ultra-thin glass meets the requirements of alignment and drop resistance performance.

In practical applications, if the CCD alignment device is unable to identify the edges of the ultra-thin glass, alignment may be performed by a mode of manual point selection.

In an optional implementation, after the step of cutting the coating layer, the preparation method further includes: forming a shielding layer on the first surface or on a side surface of the coating layer located on the first surface away from the ultra-thin glass, and the shielding layer is disposed close to an edge of the encapsulation cover plate; and/or successively adhering an adhesive film and an organic film on the second surface or on a side surface of the coating layer located on the second surface away from the ultra-thin glass.

As shown in FIG. 5, the encapsulation cover plate may be obtained by using the preparation method provided in the present embodiment.

In the present implementation, firstly, the organic film is cut, and then the shielding layer and/or the organic film are made. In this way, the alignment accuracy in the preparing process of the shielding layer and the organic film may be improved.

When the protruding amount of the coating layer after solidifying relative to the edges of the ultra-thin glass is greater than or equal to 100 microns, the preparation method provided in the present implementation may be used. In this way, the adverse effects of heat generated during laser cutting on the ultra-thin glass may be reduced.

In the specific implementation, the shielding layer may be formed by printing ink. Specifically, the printing process may be selected from screen printing, yellow light, transfer printing, inkjet, and so on.

In the specific implementation, the organic film and the ultra-thin glass are adhered by an adhesive film. The adhering process may be selected from roller adhering, slider adhering or vacuum adhering, and so on. In order to ensure the alignment accuracy and adhering effect, the vacuum adhering process may be used. At the same time, the vacuum defoaming process may also be used to remove the bubbles between the ultra-thin glass and the organic film during the adhering process, to improve the flatness of the encapsulation cover plate and reduce poor appearance.

In the present implementation, a coating layer with a controllable protruding amount and a less tolerance is obtained by using high accuracy alignment and laser cutting technology, which is conducive to the accurate positioning of the subsequent process and reduces the difficulty of the subsequent process.

In another optional implementation, before the step of cutting the coating layer, the preparation method further includes:
providing an organic film, wherein the organic film includes a first area and a peripheral area located on a periphery of the first area;
forming a shielding layer on a side of the organic film, wherein an orthographic projection of the shielding layer on the plane where the ultra-thin glass is located is located within a range of an orthographic projection of the peripheral area on the plane where the ultra-thin glass is located; and
successively adhering an adhesive film and the organic film on the second surface or on a side surface of the coating layer located on the second surface away from the ultra-thin glass, and the shielding layer on the organic film is disposed close to the ultra-thin glass; an orthographic projection of the adhesive film on the plane where the ultra-thin glass is located is located within a range of an orthographic projection of the first area on the plane where the ultra-thin glass is located.

By disposing an organic film on the encapsulation cover plate, the encapsulation performance of the encapsulation cover plate may be improved, and the external water and oxygen may be blocked from entering the display panel to react, so the performance stability of the display panel may be improved.

By using the preparation method provided in the present implementation, the protuding amount of the coating layer after solidifying relative to the edges of the ultra-thin glass is less than or equal to the protruding amount of the organic film relative to the edges of the ultra-thin glass. In addition, since the shielding layer is disposed on the side of the coating layer away from the first surface of the ultra-thin glass, and the orthographic projection of the shielding layer on the plane where the ultra-thin glass is located may cover the protruding area, that is, the shielding layer may block the overflowing coating layer, thereby improving the appearance.

The step of cutting the coating layer includes: cutting the coating layer and the organic film at a same time.

As shown in FIG. 6, the encapsulation cover plate may be obtained by using the preparation method provided in the present embodiment. When the protruding amount of the coating layer after solidifying relative to the edges of the ultra-thin glass is less than 100 microns, the preparation method provided in the present implementation may be used.

In the present implementation, firstly, a shielding layer is formed on the organic film, then the organic film with the shielding layer is adhered to the ultra-thin glass with the coating layer by using the adhesive film, and then the organic film and the coating layer are laser cut at the same time.

Various embodiments in the description are described in a progressive manner, each of the embodiments focuses on the differences with other embodiments. The same or similar parts of the various embodiments can be referred to each other.

Finally, it should also be noted that in this article, relational terms such as first and second are used only to distinguish one entity or operation from another without necessarily requiring or implying any such actual relationship or order between these entities or operations. Moreover, the term ‘including’, ‘containing’ or any other variant is intended to cover non-exclusive inclusion, so that the process, method, commodity or equipment that includes a series of elements includes not only those elements, but also other elements that are not clearly listed, or also includes the inherent elements of such process, method, commodity or equipment. Without more restrictions, the limited elements by the sentence ‘includes one . . . ’ do not exclude that there are other same elements in the process, method, commodity or equipment that include the elements.

An encapsulation cover plate and a preparation method thereof, and a display device provided by the present disclosure are introduced in detail. In this paper, the principle and embodiments of the present disclosure expounded with specific examples. The above description of the embodiments is only used to help understand the method and core idea of the present disclosure. At the same time, for the general technical personnel in the art, according to the idea of the present disclosure, there will be changes in the specific embodiments and application scope. In summary, the content of this specification should not be understood as the limitation of this disclosure.

After considering the specification and practicing the inventions disclosed here, a person skilled in the art will easily think of other embodiments of the present disclosure. The present disclosure aims to cover any variations, uses or adaptive changes in present disclosure. These variations, uses or adaptive changes follow the general principles of the present disclosure and include public knowledge or common technical means in this art that are not disclosed in the present disclosure. Specification and embodiments are only treated as illustrative, and the true scope and spirit of this disclosure are stated in the following claims.

It should be understood that the present disclosure is not limited to the precise structure described above and shown in the attached figure, and can be modified and changed in a variety of ways without leaving its scope. The scope of the present disclosure is limited only by the attached claims.

The “an embodiment”, “embodiments” or “one or more embodiments” mentioned in the disclosure means that the specific features, structures, or performances described in combination with the embodiment(s) would be included in at least one embodiment of the disclosure. Moreover, it should be noted that, the wording “in an embodiment” herein may not necessarily refer to the same embodiment.

Many details are discussed in the specification provided herein. However, it should be understood that the embodiments of the disclosure can be implemented without these specific details. In some examples, the well-known methods, structures, and technologies are not shown in detail so as to avoid an unclear understanding of the description.

In the claims, any reference signs between parentheses should not be construed as limiting the claims. The word “comprise” does not exclude elements or steps that are not listed in the claims. The word “a” or “an” preceding an element does not exclude the existing of a plurality of such elements. The present application may be implemented by means of hardware comprising several different elements and by means of a properly programmed computer. In unit claims that list several devices, some of those devices may be embodied by the same item of hardware. The words first, second, third and so on do not denote any order. Those words may be interpreted as names.

Finally, it should be noted that the above embodiments are merely intended to explain the technical solutions of the present application, and not to limit them. Although the present application is explained in detail by referring to the above embodiments, a person skilled in the art should understand that he can still modify the technical solutions set forth by the above embodiments, or make equivalent substitutions to part of the technical features of them. However, those modifications or substitutions do not make the essence of the corresponding technical solutions depart from the spirit and scope of the technical solutions of the embodiments of the present application.

1. An encapsulation cover plate, wherein the encapsulation cover plate is configured for encapsulating a display panel, and the encapsulation cover plate comprises:
an ultra-thin glass, wherein the ultra-thin glass is provided with a first surface for being close to the display panel and a second surface opposite to the first surface; and
a coating layer coated on the first surface and/or the second surface, wherein a material of the coating layer comprises an organic material.

2. The encapsulation cover plate according to claim 1, wherein edges of an orthographic projection of the coating layer on a plane where the ultra-thin glass is located is protruded relative to edges of the ultra-thin glass, and a difference between a maximum value of a protruding amount and a minimum value of the protruding amount is less than or equal to 15 microns.

3. The encapsulation cover plate according to claim 1, wherein the coating layer comprises a first coating layer and a second coating layer, and the second coating layer is coated on a side of the first coating layer away from the ultra-thin glass.

4. The encapsulation cover plate according to claim 3, wherein the coating layer comprises at least two first coating layers and at least one second coating layer, and the first coating layer and the second coating layer are alternately arranged in stacked.

5. The encapsulation cover plate according to claim 1, wherein the material of the coating layer comprises at least one of the following organic materials: polyester, polyurethane, thermoplastic polyurethane, polyamide, polyimide, polymethyl methacrylate, polyethylene, polypropylene, polyvinyl chloride, polystyrene, paraformaldehyde, polyphenylene oxide, polyphenylene sulfide, polysulfone, polyether ether ketone, styrene and polyolefin.

6. The encapsulation cover plate according to claim 5, wherein the material of the coating layer further comprises at least one of the following inorganic materials: oxides, nitrides, carbides, borides, sulfides, silicides and functional ceramics.

7. The encapsulation cover plate according to claim 1, wherein a thickness of the coating layer is greater than or equal to 15 microns, and less than or equal to 300 microns.

8. The encapsulation cover plate according to claim 1, wherein edges of an orthographic projection of the coating layer on a plane where the ultra-thin glass is located is protruded relative to edges of the ultra-thin glass.

9. The encapsulation cover plate according to claim 8, wherein a protruding amount of the edges of the orthographic projection of the coating layer on the plane where the ultra-thin glass is located relative to the edges of the ultra-thin glass is greater than or equal to 30 microns, and less than or equal to 100 microns.

10. The encapsulation cover plate according to claim 1, wherein the encapsulation cover plate further comprises:
a shielding layer disposed on the first surface or on a side surface of the coating layer located on the first surface away from the ultra-thin glass, wherein the shielding layer is disposed close to an edge of the encapsulation cover plate; and/or
an adhesive film and an organic film arranged in stacked on the second surface or arranged in stacked on a side surface of the coating layer located on the second surface away from the ultra-thin glass, wherein the organic film is disposed on a side of the adhesive film away from the ultra-thin glass.

11. The encapsulation cover plate according to claim 1, wherein the encapsulation cover plate further comprises:
an adhesive film and an organic film arranged in stacked on the second surface or arranged in stacked on a side surface of the coating layer located on the second surface away from the ultra-thin glass, wherein the organic film is disposed on a side of the adhesive film away from the ultra-thin glass, the organic film comprises a first area and a peripheral area located on a periphery of the first area, and an orthographic projection of the adhesive film on the plane where the ultra-thin glass is located is located within a range of an orthographic projection of the first area on the plane where the ultra-thin glass is located; and
a shielding layer disposed on a side of the organic film close to the ultra-thin glass, wherein an orthographic projection of the shielding layer on the plane where the ultra-thin glass is located is located within a range of an orthographic projection of the peripheral area on the plane where the ultra-thin glass is located.

12. The encapsulation cover plate according to claim 11, wherein the orthographic projection of the coating layer on the plane where the ultra-thin glass is located is provided with a protruding area, wherein the protruding area does not overlap with the ultra-thin glass, and the orthographic projection of the shielding layer on the plane where the ultra-thin glass is located covers the protruding area.

13. The encapsulation cover plate according to claim 11, wherein the orthographic projection of the organic film on the plane where the ultra-thin glass is located covers the orthographic projection of the coating layer on the plane where the ultra-thin glass is located.

14. A display device, wherein the display device comprises the display panel and the encapsulation cover plate according to claim 1, the encapsulation cover plate is located at a light-emitting side of the display panel, and the first surface is disposed close to the display panel.

15. A preparation method of an encapsulation cover plate, wherein the encapsulation cover plate is configured for encapsulating a display panel, and the preparation method comprises:
providing an ultra-thin glass, wherein the ultra-thin glass is provided with a first surface for being close to the display panel and a second surface opposite to the first surface; and
coating on the first surface and/or the second surface to form a coating layer, wherein a material of the coating layer comprises an organic material.

16. The preparation method according to claim 15, wherein the step of coating on the first surface and/or the second surface to form a coating layer comprises:
providing a substrate film, wherein a material of the substrate membrane is an organic material;
adhering the substrate film to the first surface or the second surface of the ultra-thin glass, wherein edges of an orthographic projection of the substrate film on the plane where the ultra-thin glass is located is protruded relative to edges of the ultra-thin glass;
coating an organic solution on a side surface of the ultra-thin glass away from the substrate film, and solidifying the organic solution to form the coating layer; and
stripping the substrate film.

17. The preparation method according to claim 15, wherein after the step of coating on the first surface and/or the second surface to form a coating layer, the preparation method further comprises:
determining edges of the ultra-thin glass; and
based on the edges of the ultra-thin glass, cutting the coating layer, so that edges of an orthographic projection of the cut coating layer on the plane where the ultra-thin glass is located is protruded relative to edges of the ultra-thin glass, and a difference between a maximum value of a protruding amount and a minimum value of the protruding amount is less than or equal to 15 microns.

18. The preparation method according to claim 17, wherein after the step of cutting the coating layer, the preparation method further comprises:
forming a shielding layer on the first surface or on a side surface of the coating layer located on the first surface away from the ultra-thin glass, wherein the shielding layer is disposed close to an edge of the encapsulation cover plate; and/or
successively adhering an adhesive film and an organic film on the second surface or on a side surface of the coating layer located on the second surface away from the ultra-thin glass.

19. The preparation method according to claim 17, wherein before the step of cutting the coating layer, the preparation method further comprises:
providing an organic film wherein the organic film comprises a first area and a peripheral area located on a periphery of the first area;
forming a shielding layer on a side of the organic film, wherein an orthographic projection of the shielding layer on the plane where the ultra-thin glass is located is located within a range of an orthographic projection of the peripheral area on the plane where the ultra-thin glass is located;
successively adhering an adhesive film and the organic film on the second surface or on a side surface of the coating layer located on the second surface away from the ultra-thin glass, and the shielding layer on the organic film is disposed close to the ultra-thin glass; an orthographic projection of the adhesive film on the plane where the ultra-thin glass is located is located within a range of an orthographic projection of the first area on the plane where the ultra-thin glass is located; and
the step of cutting the coating layer comprises:
cutting the coating layer and the organic film at a same time.
